(19) United States
(12) Patent Application Publication
(10) Pub. No.: US 2009/0001021 A1
(43) Pub. Date: Jan. 1, 2009

(54) Air filtration media comprising non-metal-doped precipitated silica and/or silicon-based gel materials

(76) Inventors: Michael C. Withiam, Landenberg, PA (US); Fitzgerald A. Sinclair, Smyrna, DE (US)

Correspondence Address: J.M. Huber Corporation Law Department, 333 Thornall Street, Edison, NJ, 08837, US

(21) Appl. No.: 11/823,349

(22) Filed: Jun. 27, 2007

(51) Int. Cl. B01D 15/04; B01D 39/00

(52) U.S. Cl. 210/660; 210/510.1

(57) ABSTRACT

The present invention relates generally to an environmental control unit for use in air handling systems that provides highly effective filtration of noxious gases (such as ammonia). Such a filtration system utilizes novel undoped precipitated silica or silicon-based gels to temporarily trap and remove such undesirable gases from an enclosed environment and permit recycling of such gases subsequently thereto. Such precipitated silicas need to exhibit specific pore sizes, pore volumes, pore diameters, and particles sizes to be effective for such a purpose. The combination of these particular properties permits highly effective noxious gas filtration such that excellent uptake and breakthrough results are attained, particularly in comparison with prior media filtration products. Methods of using and specific filter apparatuses are also encompassed within this invention.

### FIELD OF THE INVENTION

The present invention relates generally to an environmental control for use in air handling systems that provides highly effective filtration of noxious gases (such as ammonia). Such a filtration system utilizes novel undoped precipitated silicas or silicon-based gels to temporarily trap and remove such undesirable gases from an enclosed environment and permit recycling of such gases subsequently thereto. Such precipitated silicas need to exhibit specific pore sizes, pore volumes, pore diameters, and particles sizes to be effective for such a purpose. The combination of these particular properties permits highly effective noxious gas filtration such that excellent uptake and breakthrough results are attained, particularly in comparison with prior media filtration products. Methods of using and specific filter apparatuses are also encompassed within this invention.

### BACKGROUND OF THE INVENTION

There is an ever-increasing need for air handling systems that include air filtration systems that can be deployed to protect an enclosure against noxious airborne agents released in the vicinity of the enclosure. Every year there are numerous incidents of noxious fumes entering buildings and causing illness and disruptions due to accidents or other reasons. There also currently exists heightened awareness of toxic airborne agents being released as part of possible terrorist acts. In addition, military personnel in combat areas may need protection from enemy releases of airborne noxious agents both inside and outside enclosures. Whether a civilian or military setting, a typical air filtration system is generally ineffective against most noxious gases and agents. For example, standard dust filters, such as cardboard framed fiberglass matt filters, exhibit very low propensity for removing micro-sized particles and gases. Commercially available electrostatic fiber filters have higher efficiencies than standard dust filters and can remove pollens and other small solid particulates, but they can not intercept and remove gases. HEPA (“High-Efficiency Particulate Air”) filters are known that are used for high-efficiency filtration of airborne dispersions of ultra fine solid and liquid particulates such as dust and pollen, radioactive particle contaminants, and aerosols. However, where the threat is a gaseous chemical compound or a gaseous particle of extremely small size (i.e., <0.001 microns), the conventional commercially-available HEPA filters cannot intercept and control those types of airborne agents. Furthermore, there is also a need to provide filter media that will temporarily (but securely) trap such gases and permit easy release for recyclability purposes. Since some gases, such as ammonia, may provide important benefits through reclamation and subsequent reuse, the ability to permit such a result is highly desired, particularly with a relatively simple-to-use filter medium.

The most commonly found filter technology used to remove gaseous substances and materials from an airflow is based on activated carbon. Such gas filtration has been previously implemented in certain applications, such as in gas masks or in industrial processes, by using filter beds of activated impregnated carbons or other sorbents for ultra-high-efficiency filtration of super toxic chemical vapors and gases from an air or gas stream passed through the filter. Commercial filters of this sort generally include activated carbon loaded nonwovens, in which the activated carbon is bonded to a nonwoven fiber mat. Carbon filters used for protection against toxic chemicals are typically designed to maintain an efficiency of at least 99.999% removal of airborne particulates. An activated carbon filter typically functions by removing molecules from an air stream by adsorption in which molecules are entrapped in pores of the carbon granules.

Activated carbons are useful in respirators, collective filters and other applications, and often involved the use of special impregnates to remove gases that would not otherwise be removed through the use of unimpregnated activated carbons. These impregnated activated carbon adsorption for removal of toxic gases and/or vapors have been known and used for many years. The prior art formulations often contain copper, chromium and silver impregnated on an activated carbon. These adsorbents are effective in removing a large number of toxic materials, such as cyamide-based gases and vapors.

In addition to a number of other inorganic materials, which have been impregnated on activated carbon, various organic impregnants have been found useful in military applications for the removal of cyanogen chloride. Examples of these include triethylenediamine (TEDA) and pyridine-4-carboxylic acid.

Various types of high-efficiency filter systems, both commercial and military systems, have been proposed for building protection using copper-silver-zinc-molybdenum-triethylenediamine impregnated carbon for filtering a broad range of toxic chemical vapors and gases. However, such carbon-based filters have proven ineffective for other gases, such as, ammonia, ethylene oxide, formaldehyde, and carbon disulfide. As these other gases are quite prominent in industry and effectively harmful to humans when present in certain amounts (particularly within enclosed spaces), and, to date, other filter devices have proven unsuitable for environmental treatment and/or removal, there exists a definite need for a filter mechanism to remedy these deficiencies. Furthermore, such a specific type of filter medium has proven ineffective to requisite levels of gas removal when the relative humidity of the target environment is too high. To date, no proper filtration system having a relatively small amount of filter medium present has been provided that effectively removes such gases, particularly ammonia, for long durations of time with an uptake and breakthrough that correlates to an acceptable efficiency level and thus proper performance at a suitable cost, and, additionally, that exhibits effective noxious gas removal at relative humidity levels of greater than 50%.

It has been realized that silica-based compositions permit excellent gas filter media. However, there has been little provided within the pertinent prior art that concerns the ability to provide uptake and breakthrough levels by such filter media on a permanent basis and at levels that are acceptable for large-scale usage. Uptake basically is a measure of the ability of the filter medium to capture a certain volume of the subject gas; breakthrough is an indication of the saturation point for the filter medium in terms of capture. Thus, it is highly desirable to find a proper filter medium that exhibits a high uptake (and thus quick capture of large amounts of noxious gases) and long breakthrough times (and thus, coupled with uptake, the ability to not only effectuate quick capture but also extensive lengths of time to reach saturation). The standard filters in use today are limited for noxious gases, such as ammonia, to slow uptake and relatively quick breakthrough times. There is a need to develop a new filter medium that reduces uptake and increases breakthrough and does so using a more economical silica substrate.

The closest art concerning the removal of gases such as ammonia utilizing a potential silica-based compound is taught within WO 00/40324 to Kemira Agro Oy, which requires a metal-doped silica product. Such a material does exhibit excellent ammonia removal and regeneration potential (upon an increase of the temperature to which the used filter medium is exposed); however, such a metal-doped product is quite expensive to produce in comparison with undoped materials and requires proper disposal after use as the metal dopant may leach from the base material over time and upon exposure to moisture. The details of the inventive filter media are discussed in greater depth below.

### BRIEF DESCRIPTION OF THE INVENTION

According to one aspect of this invention, a filter medium comprising precipitated silica or silica gel materials, wherein said materials exhibit a BET surface area of between about 30 and 350 m²/g; a pore volume of greater than 0.25 cc/g to 2.0 cc/g as measured by nitrogen porosimetry; a mean pore diameter of greater than about 100 to 300 Å. A method of removing ammonia from an enclosed environment utilizing such a filter medium and subsequently releasing such ammonia therefrom is also one aspect of this invention.

According to another aspect of the invention, a precipitated silica or silica gel filter medium that exhibits a breakthrough measurement for an ammonia gas/air composition of at least 50 minutes a) when present as a filter bed of 1 cm in height within a flask of a diameter of 4.1 cm, b) when exposed to a constant ammonia gas concentration of 1000 mg/m³ ammonia gas at ambient temperature and pressure, and c) when exposed simultaneously to a relative humidity of at least 15%; and wherein said filter medium, after breakthrough concentration of 35 mg/m³ is reached, does not exhibit any ammonia gas elution in excess of said breakthrough concentration, is provided. Preferably, the breakthrough time is at least 100 minutes. Additionally, another aspect of this invention concerns precipitated silica materials that exhibit a breakthrough time of at least 50 minutes when exposed to the same conditions as listed above and within the same test protocol, except that the relative humidity is 80%. Preferably, the breakthrough time for such a high relative humidity exposure test example is at least 100 minutes, as well. Furthermore, said filter medium will also exhibit substantial regeneration potential of the ammonia upon exposure to a temperature in excess of about 75° C. for at least 10 minutes.

One distinct advantage of this invention is the provision of a filter medium that exhibits highly effective ammonia uptake and breakthrough properties when present in a relatively low amount and under a pressure typical of an enclosed space and over a wide range of relative humidity. Among other advantages of this invention is the provision of a filter system for utilization within an enclosed space that exhibits a steady and effective uptake and breakthrough result for ammonia gas and that removes such noxious gases from an enclosed space at a suitable rate for reduction in human exposure below damage levels. Yet another advantage is the ability of this invention to irreversibly prevent release of noxious gases once adsorbed, under normal conditions. Additionally, precipitated silica materials are more cost effective than other absorbent alternatives. Also, said invention encompasses a filter system wherein at least 15% by weight of such a filter medium has been introduced therein.

### DETAILED DESCRIPTION OF THE INVENTION

For purposes of this invention, the term “precipitated silica” is intended to encompass materials that are formed from the reaction of a metal silicate (such as sodium silicate) with an acid (such as sulfuric acid) to form an amorphous solid silica material. Typically precipitated silicas are distinguished from silica gels by their higher pH, such as greater than 6 pH, lower surface areas measured by nitrogen porosimetry typically less than 350 m²/g and larger median pore diameters above 100′. Such materials may be categorized as silicon dioxide, precipitated silica, hydrated silica, colloidal silicon dioxide, amorphous precipitated silica or dental grade silica. The difference between these categories lies strictly within the naming and intended use. In any event, as noted above, the term “precipitated silica” is intended to encompass any and all of these types of materials. It has been found that precipitated silicas exhibiting a resultant pH of less than about 8.0 contain a percentage of micropores of size less than 20′, and a median pore diameter of about 100 to 300′. While not wishing to be held by theory, it is believed that capture of toxic gases, such as ammonia, is accomplished by two separate (but potentially simultaneous) occurrences within the pores of the metal-doped precipitated silicas: acid-base reaction and complexation reaction. Thus precipitated silicas contain a combination of large pores for quick gas uptake and mass transport and smaller pores connected to such large pores within which metal may be deposited. Basically, it is believed, without being bound to any specific scientific theory, once the gas enters the large pores, it liquefies and becomes entrapped within the smaller pores attached thereto. It is believed that the amount of a gas such as ammonia that is captured and held by the precipitated silica results from a combination of these two means. The ability to tailor the pore sizes in order to best permit such a mechanism therein is thus a particularly interesting subject of the invention.

Precipitated silica may be produced by reacting an alkali metal silicate and a mineral acid in an aqueous medium. If desired, in order to provide a more uniform structure to the precipitated silica product, a template method may be followed utilizing a compound, such as cetyltrimethylammonium bromide, that imparts an underlying structure to which the silica components can be adhered to and arranged in like fashion. Such a method (which may be followed for silicon-based gels as well within this invention) is described within, as one example, Edler, K. J., et al., Formation Mechanisms in Surfactant Templated Films, Isis Science. When the quantity of acid reacted with the silicate is such that the final pH of the reaction mixture is alkaline, the resulting product is considered to be precipitated silica. Sulfuric acid is the most commonly used acid, although other mineral acids such as hydrochloric acid, nitric acid, or phosphoric acid may be used. Sodium or potassium silicate may be used, for example, as the alkali metal silicate. Sodium silicate is preferred because it is the least expensive and most readily available. The concentration of the aqueous acidic solution is generally from about 5 to about 70 percent by weight and the aqueous silicate solution commonly has an SiO₂ content of about 6 to about 25 weight percent and a molar ratio of SiO₂ to Na₂O of from about 1:1 to about 3.4:1.

The mineral acid is added to the metal silicate solution to form precipitated silica. Alternatively, a portion of the metal silicate is first added to a reactor to serve as the reaction medium and then the remaining metal silicate and the mineral acid are added simultaneously to the medium. Generally, continuous processing can be employed and mineral acid is metered separately into a high speed mixer. The reaction may be carried out at any convenient temperature, for example, from about 15 to about 100° C. and is generally carried out at temperatures between 60 and 90° C.

The silica will generally precipitate directly from the admixture of the reactants and is then washed with water or an aqueous acidic solution to remove residual alkali metal salts which are formed in the reaction. For example, when sulfuric acid and sodium silicate are used as the reactants, sodium sulfate is entrapped in the precipitated silica wet mass. Prior to washing, the mass may be further adjusted with additional mineral acid as is necessary to achieve the desired final pH. The mass may be washed with an aqueous solution of mineral acid such as sulfuric acid, hydrochloric acid, nitric acid, or phosphoric acid or a medium strength acid such as formic acid, acetic acid, or propionic acid.

Generally, the temperature of the wash medium is from about 27° C. to about 93° C. Preferably, the wash water is at a temperature of from about 50° C. to about 93° C. The silica wet mass is washed for a period sufficient to reduce the total salts content to less than about 5 weight percent. The mass may have, for example, a Na₂O content of from about 0.05 to about 3 weight percent and a SO₄ content of from about 0.05 to about 3 weight percent, based on the dry weight of the precipitated silica. The period of time necessary to achieve this salt removal varies with the flow rate of the wash medium and the configuration of the washing apparatus. Generally, the period of time necessary to achieve the desired salt removal is from about 0.05 to about 3 hours. Thus, it is preferred that the precipitated silica mass be washed with water at a temperature of from about 50° C. to about 93° C. for about 0.05 to about 3 hours. In one potential embodiment, the washing may be limited in order to permit a certain amount of salt (such as sodium sulfate), to be present on the surface and within the pores of the silica material. Such salt is believed, without intending on being limited to any specific scientific theory, to contribute a level of hydration that may be utilized for the subsequent metal doping procedure to effectively occur.

In order to prepare hydrous precipitated silicas suitable for use in the filter media of this invention, the final silica pH upon completion of washing as measured in 5 weight percent aqueous slurry of the silica, may range from about 6 to about 8.

The washed precipitated silica mass generally has a water content, as measured by oven drying at 105° C. for about 16 hours, of from 10 to about 60 weight percent and a particle size ranging from about 1 micron to about 50 millimeters. Alternatively the precipitated silica is then dewatered to a desired water content of from about 20 to about 90 weight percent, preferably from about 50 to about 85 weight percent. Any known dewatering method may be employed to reduce the amount of water therein or conversely increase the solids content thereof. For example, the washed precipitated silica mass may be dewatered in a filter, rotary dryer, spray dryer, tunnel dryer, flash dryer, nozzle dryer, fluid bed dryer, cascade dryer, and the like.

The average particle size referred to throughout this specification is determined in a MICROTRAC® particle size analyzer. When the water content of the precipitated silica is greater than about 20 weight percent, the precipitated silica may be pre-dried in any suitable dryer at a temperature and for a time sufficient to reduce the water content of the precipitated silica to below about 50 weight percent to facilitate handling, processing, and subsequent metal doping.

The precipitated silica particles may be ground to relatively uniform particles sizes concurrently during doping or subsequent to the doping step. One option is to subject the precipitated silica materials to high shear mixing during the metal doping procedure. In such a step, the particle sizes can be reduced to the sizes necessary for proper filter utilization. In such alternative manners, the overall production method can effectuate the desired homogeneous impregnation of the metal for the most effective noxious gas removal upon utilization as a filter medium.

Thus, in one possible embodiment, the precipitated silica is wet ground in a mill in order to provide the desired average particle size suitable for further reaction with the metal dopant and the subsequent production of sufficiently small pore sizes for the most effective ammonia gas trapping and holding while present within a filter medium. For example, the precipitated silica may be concurrently ground and dried with any standard mechanical grinding device, such as a hammer mill, as one non-limiting example. The ultimate particle sizes of the filter medium precipitated silica materials are dependent upon the desired manner of providing the filter medium made therefrom. Thus, packed media will require larger particle sizes (from 100 microns to 5 millimeters, for example) whereas relatively small particles sizes (from 1 to 100 microns, for example) may be utilized as extrudates within films or fibers. The important issue, however, is not the particle sizes in general, but the degree of homogeneous pore sizes and diameters effectuated within the subject precipitated silicas themselves.

For purposes of this invention, the term “silicon-based gel” is intended to encompass materials that are formed from the reaction of a metal silicate (such as sodium silicate) with an acid (such as sulfuric acid) and permitted to age properly to form a gel material or materials that are available from a natural source (such as from rice hulls) and exhibit pore structures that are similar to such gels as formed by the process above. Such synthetic materials may be categorized as either silicic acid or polysilicic acid types or silica gel types, whereas the natural source materials are typically harvested in a certain form and treated to ultimately form the final gel-like product (such a method is provided within U.S. Pat. No. 6,638,354). The difference between the two synthetic categories lies strictly within the measured resultant pH level of the gel after reaction, formation and aging. If the gel exhibits a pH of below 3.0 after that stage, the gel is considered silicic or polysilicic acid in type. If pH 3.0 or above, then the material is considered a (traditional) silica gel. In any event, as noted above, the term “silicon-based gel” is intended to encompass both of these types of gel materials. It has been found that silicon-based gels exhibiting a resultant pH of less than 3.0 (silicic or polysilicic acid gels) contain a larger percentage of micropores of size less than 20′ with a median pore size of about 30′, while silicon-based gels exhibiting a higher acidic pH, such as pH of 3.0 and above (preferably, though not necessarily, as high as 4) contain a mixture of pore sizes having a median pore size of about 30′ to about 60′. The synthetic variety may be produced following a template method as described above and as exemplified below.

The hydrous silicon-based gels that are used for the desired air filtration medium may be prepared from acid-set silica hydrogels. Silica hydrogel may be produced by reacting an alkali metal silicate and a mineral acid in an aqueous medium to form a silica hydrosol and allowing the hydrosol to set to a hydrogel. When the quantity of acid reacted with the silicate is such that the final pH of the reaction mixture is acidic, the resulting product is considered an acid-set hydrogel. Sulfuric acid is the most commonly used acid, although other mineral acids such as hydrochloric acid, nitric acid, or phosphoric acid may be used. Sodium or potassium silicate may be used, for example, as the alkali metal silicate. Sodium silicate is preferred because it is the least expensive and most readily available. The concentration of the aqueous acidic solution is generally from about 5 to about 70 percent by weight and the aqueous silicate solution commonly has an SiO₂ content of about 6 to about 25 weight percent and a molar ratio of SiO₂ to Na₂O of from about 1:1 to about 3.4:1.

The alkali metal silicate solution is added to the mineral acid solution to form a silica hydrosol. The relative proportions and concentrations of the reactants are controlled so that the hydrosol contains about 6 to about 20 weight percent SiO₂ and has a pH of less than about 5 and commonly between about 1 to about 4. Generally, continuous processing is employed and alkali silicate is metered separately into a high speed mixer. The reaction may be carried out at any convenient temperature, for example, from about 15 to about 80° C. and is generally carried out at ambient temperatures.

The silica hydrosol will set to a hydrogel in generally about 5 to about 90 minutes and is then washed with water or an aqueous acidic solution to remove residual alkali metal salts which are formed in the reaction. For example, when sulfuric acid and sodium silicate are used as the reactants, sodium sulfate is entrapped in the hydrogel. Prior to washing, the gel is normally cut or broken into pieces in a particle size range of from about ½ to about 3 inches. The gel may be washed with an aqueous solution of mineral acid such as sulfuric acid, hydrochloric acid, nitric acid, or phosphoric acid or a medium strength acid such as formic acid, acetic acid, or propionic acid.

Generally, the temperature of the wash medium is from about 27° C. to about 93° C. Preferably, the wash medium is at a temperature of from about 27° C. to about 38° C. The gel is washed for a period sufficient to reduce the total salts content to less than about 5 weight percent. The gel may have, for example, a Na₂O content of from about 0.05 to about 3 weight percent and a SO₄ content of from about 0.05 to about 3 weight percent, based on the dry weight of the gel. The period of time necessary to achieve this salt removal varies with the flow rate of the wash medium and the configuration of the washing apparatus. Generally, the period of time necessary to achieve the desired salt removal is from about 0.5 to about 3 hours. Thus, it is preferred that the hydrogel be washed with water at a temperature of from about 27° C. to about 38° C. for about 0.5 to about 3 hours.

In order to prepare hydrous silicon-based gels suitable for use in the filter media of this invention, the final gel pH upon completion of washing as measured in 5 weight percent aqueous slurry of the gel, may range from about 1.5 to about 5.

The washed silica hydrogel generally has a water content, as measured by oven drying at 105° C. for about 16 hours, of from 10 to about 60 weight percent and a particle size ranging from about 1 micron to about 50 millimeters. Alternatively the hydrogel is then dewatered to a desired water content of from about 20 to about 90 weight percent, preferably from about 50 to about 85 weight percent. Any known dewatering method may be employed to reduce the amount of water therein or conversely increase the solids content thereof. For example, the washed hydrogel may be dewatered in a filter, rotary dryer, spray dryer, tunnel dryer, flash dryer, nozzle dryer, fluid bed dryer, cascade dryer, and the like.

The average particle size referred to throughout this specification is determined in a MICROTRAC® particle size analyzer. When the water content of the hydrogel is greater than about 90 weight percent, the hydrogel may be pre-dried in any suitable dryer at a temperature and for a time sufficient to reduce the water content of the hydrogel to below about 85 weight percent to facilitate handling and processing.

Generally, the hydrogel materials after formation and aging are of very coarse sizes and thus should be broken apart to facilitate proper metal impregnation. Such a size reduction may be accomplished by various methods, including milling, grinding, and the like. One option, however, is to subject the hydrogel materials to high shear mixing during the metal doping procedure. In such a step, the particle sizes can be reduced to the sizes necessary for proper filter utilization. In such alternative manners, the overall production method can effectuate the desired homogeneous impregnation of the metal for the most effective noxious gas removal upon utilization as a filter medium.

Thus, in one possible embodiment, the silica hydrogel is wet ground in a mill in order to provide the desired average particle size suitable for further reaction with the metal dopant and the subsequent production of sufficiently small pore sizes for the most effective ammonia gas trapping and holding while present within a filter medium. For example, the hydrogels may be concurrently ground and dried with any standard mechanical grinding device, such as a hammer mill, as one non-limiting example. The ultimate particle sizes of the silicon-based gel materials are dependent upon the desired manner of providing the filter medium made therefrom. Thus, packed media will require larger particle sizes (from 10 to 100 microns, for example) whereas relatively small particles sizes (from 1 to 20 microns, for example) may be utilized as extrudates within films or fibers. The important issue, however, is not the particle sizes in general, but the degree of homogeneous pore sizes, diameters, etc., of the subject hydrogels themselves.

The filter medium of the invention can also further contain as optional ingredients, silicates, clays, talcs, aluminas, carbons, polymers, including but not limited to polysaccharides, gums or other substances used as binder fillers. These are conventional components of filter media, and materials suitable for this purpose need not be enumerated for they are well known to those skilled in the art. Furthermore, such metal-doped precipitated silica materials of the invention may also be introduced within a polymer composition (through impregnation, or through extrusion) to provide a polymeric film, composite, or other type of polymeric solid for utilization as a filter medium. Additionally, a nonwoven fabric may be impregnated, coated, or otherwise treated with such invention materials, or individual yarns or filaments may be extruded with such materials and formed into a nonwoven, woven, or knit web, all to provide a filter medium base as well. Additionally, the inventive filter media may be layered within a filter canister with other types of filter media present therewith (such as layers of carbon black material), or, alternatively, the filter media may be interspersed together within the same canister. Such films and/or fabrics, as noted above, may include discrete areas of filter medium, or the same type of interspersed materials (carbon black mixed on the surface, or co-extruded, as merely examples, within the same fabric or film) as well.

The filter system utilized for testing of the viability of the medium typically contains a media bed thickness of from about 1 cm to about 3 cm thickness, preferably about 1 cm to about 2 cm thickness within a flask of 4.1 cm in diameter. Without limitation, typical filters that may actually include such a filter medium, for example, for industrial and/or personal use, will comprise greater thicknesses (and thus amounts) of such a filter medium, from about 1-15 cm in thickness and approximately 10 cm in diameter, for example for personal canister filter types, up to 100 cm in thickness and 50 cm in diameter, at least, for industrial uses. Again, these are only intended to be rough approximations for such end use applications; any thickness, diameter, width, height, etc., of the bed and/or the container may be utilized in actuality, depending on the length of time the filter may be in use and the potential for gaseous contamination the target environment may exhibit. The amount of filter medium that may be introduced within a filter system in any amount, as long as the container is structurally sufficient to hold the filter medium therein and permits proper airflow in order for the filter medium to properly contact the target gases.

It is important to note that although ammonia gas is the test subject for removal by the inventive filter media discussed herein, such media may also be effective in removing other noxious gases from certain environments as well, including formaldehyde, nitrous oxide, and carbon disulfide, as merely examples.

As previously mentioned, the filter medium can be used in filtration applications in an industrial setting (such as protecting entire industrial buildings or individual workers, via masks), a military setting (such as filters for vehicles or buildings or masks for individual troops), commercial/public settings (office buildings, shopping centers, museums, governmental locations and installations, and the like). Specific examples may include, without limitation, the protection of workers in agricultural environments, such as within poultry houses, as one example, where vast quantities of ammonia gas can be generated by animal waste. Thus, large-scale filters may be utilized in such locations, or individuals may utilize personal filter apparatuses for such purposes. Furthermore, such filters may be utilized at or around transformers that may generate certain noxious gases. Generally, such inventive filter media may be included in any type of filter system that is necessary and useful for the removal of potential noxious gases in any type of environment.

### Preferred Embodiments of the Invention

The % solids of the adsorbent wet cake were determined by placing a representative 2 g sample on the pan of a CEM 910700 microwave balance and drying the sample to constant weight. The weight difference is used to calculate the % solids content.

Pack or tapped density is determined by weighing 100.0 grams of product into a 250-mL plastic graduated cylinder with a flat bottom. The cylinder is closed with a rubber stopper, placed on the tap density machine and run for 15 minutes. The tap density machine is a conventional motor-gear reducer drive operating a cam at 60 rpm. The cam is cut or designed to raise and drop the cylinder a distance of 2.25 in. (5.715 cm) every second. The cylinder is held in position by guide brackets. The volume occupied by the product after tapping was recorded and pack density was calculated and expressed in g/ml.

The conductivity of the filtrate was determined utilizing an Orion Model 140 Conductivity Meter with temperature compensator by immersing the electrode epoxy conductivity cell (014010) in the recovered filtrate or filtrate stream. Measurements are typically made at a temperature of 15-20° C.

Surface area is determined by the BET nitrogen adsorption methods of Brunaur et al., J. Am. Chem. Soc., 60, 309 (1938).

Accessible porosity has been obtained using nitrogen adsorption-desorption isotherm measurements. The BJH (Barrett-Joiner-Halender) model average pore diameter was determined based on the desorption branch utilizing an Accelerated Surface Area and Porosimetry System (ASAP 2010) available from Micromeritics Instrument Corporation, Norcross, Ga. Samples were out gassed at 150-200° C. until the vacuum pressure was about 5 μm of Mercury. This is an automated volumetric analyzer at 77° K. Pore volume is obtained at pressure P/P₀=0.99. Average pore diameter is derived from pore volume and surface area assuming cylindrical pores. Pore size distribution (ΔV/ΔD) is calculated using BJH method, which gives the pore volume within a range of pore diameters. A Halsey thickness curve type was used with pore size range of 1.7 to 300.0 nm diameter, with zero fraction of pores open at both ends.

Adsorbent micropore area (S_{micro}) is derived from the Halsey isotherm equation used in producing a t-plot. The t-plot compares a graph of the volume of nitrogen absorbed by the adsorbent as compared with the thickness of the adsorbent layer to an ideal reference. The shape of the t-plot can be used to estimate the micropore surface area. Percent microporosity is then estimated by subtracting the external surface area from the total BET surface area, where S_{micro}=S_{BET}−Sₑₓₜ. Thus % BJH microporosity=S_{micro}/S_{BET}X 100.

### Filter Medium Production

### EXAMPLE 1

### Initial Silicic Acid Gel

Particles of silicic acid were produced by taking 100 ml of 11% sulfuric acid solution and adding a solution of 12% silicate solution containing 76.2% SiO₂ and 23.8% Na₂O until the pH of the solution reached 1.8. The temperature was then increased to 105° C. until silicic acid pigment gel was formed. The gel was then broken and washed with water, then with isopropyl alcohol. The resultant gel was then dried at 105° C. for 16 hours. The dried material was then sieved to recover silicic acid absorbent with a <20 to >40 mesh filter.

### EXAMPLE 2

### Templated High Surface Area Gel

Particles of silicic acid were produced by preparing reaction medium using 1840 g deionized water stirred at 200 rpm and into which 48 g of CTAB (Hexadecyltrimethylammonium bromide) was then dissolved. To this, 176 ml of concentrated hydrochloric acid was then added. 240 ml of silicic acid pigment suspension as described in Example 1 was then added at 8% solids at a rate of 20 ml/min with stirring. The resultant mixture was then agitated with stirring for an additional 60 minutes. Subsequently, the sample was then filtered and wash until no foaming was observed, and then dried at 105° C. for 16 hours. The resultant material was then calcined for 4 hours after increasing the temperature from ambient to 450° C. at a rate of 2° C./min. Upon completion, the temperature was then subsequently ramped at a rate of 10° C./min to a level of 550° C. and held for 8 hours. The resultant calcined material was then collected and sieved in a <20 to >40 mesh filter to provide a silicic acid absorbent.

### EXAMPLE 3

### Silicic Acid Gel Standard, pH 1.8, 3 h Gel @ 75° C.

Particles of silicic acid were produced by taking 1000 ml of 11% sulfuric acid solution and adding a solution of 24.7% silicate solution containing 76.2% SiO₂ and 23.8% Na₂O until the pH of the solution reached 1.8. Silicic acid pigment suspension formed upon aging at 3 hours at ambient temperature. The resultant suspension was then placed in an oven at 75° C. to complete gel formation. The formed gel was then broken and washed with water to a conductivity of filtrate less than 300 mhos. The resultant gel was then dewatered and dried at 75° C. for 16 hours. The dried material was then sieved to recover a silicic acid absorbent through the same size mesh filter as above.

### EXAMPLE 4

### Silicic Acid Gel Standard, pH3, 3 h Gel @ 75° C. Acid Treated

Particles of silicic acid were produced by taking 1000 ml of 11% sulfuric acid solution and adding a solution of 24.7% silicate solution containing 76.2% SiO₂ and 23.8% Na₂O until the pH of the solution reached 1.8. Silicic acid pigment suspension formed upon aging for 3 hours at ambient temperature. The suspension was then placed into an oven at 75° C. to complete gel formation. The formed gel was then broken and washed with water to a conductivity of filtrate less than 300 mhos. The resultant gel was then dewatered and dried at 75° C. for 16 hours to form a wetcake. Using the recovered silicic acid wetcake, the gel was then broken again and washed with water again to a conductivity of filtrate less than 800 mhos. The gel was then again dewatered and recovered as silicic acid absorbent. The dried absorbent was mixed with water in a high shear mixer until small granules were formed and dried at 300° C. for 16 h.

### EXAMPLE 5

### Very High SFA Templated

Particles of silicic acid were produced by taking 150 ml of 11% sulfuric acid solution and adding a solution of 15% silicate solution containing 76.2% SiO₂ and 23.8% Na₂O until the pH of the solution reached 1.8. Silicic acid pigment suspension then formed as above. A separate reaction medium of 2000 ml of deionized water and dissolved 48 g of CTAB (Hexadecyltrimethylammonium bromide) was then prepared and mixed with the silicic acid pigment suspension. To this mixture was then added 150 ml of concentrated HCl. 420 ml of silicic acid pigment suspension was then added thereto at a rate of 20 ml/min with stirring (for an additional 10 minutes thereafter). The resultant product was then filtered and washed until no foaming was observed and dried at 105° C. for 16 hours. The sample was then calcined for 4 hours after increasing the temperature from ambient to 450° C. at a rate of 2° C./min. Thereafter, the temperature was then ramped at 10° C./min to 550° C. and held for 8 hours. This resultant calcined material was collected and sieved (same mesh filter as above) to provide a silicic acid absorbent.

### COMPARATIVE EXAMPLE 1

### Typical Silica Gel

Particles of commercially available Silica Gel 408 Type RD desiccant grade silica gel available from W.R. Grace & Company, Columbia, Md., were sized by sieving as previously described above to recover particles sized between 850 μm and 425 μm. Physical properties of Comparative Example 1 were determined according to the methods described above and results are summarized below in Table 2.

### COMPARATIVE EXAMPLE 2

### Humid Typical Silica Gel

Particles of the silica gel from Comparative Example 1 were loaded into a cell that allowed airflow of a constant volume closed loop system to be recycled through the cell. A known quantity of water was injected into the system to increase the relative humidity. The resultant product was then collected for further use.

### COMPARATIVE EXAMPLE 3

### Conventional Precipitated Silica

Amorphous porous absorbent was produced by adding sulfuric acid to a dilute waterglass solution into a well agitated mixing vessel to effect the precipitation of amorphous hydrated silica. In this example, a total of 278 gallons of sulfuric acid at a concentration of 11.5% was added at a rate of 4.7 gpm to 500 gallons of waterglass solution containing 13% sodium silicate solids with mixing at a temperature 95° C. Addition of the sulfuric acid was continued until a pH of 5.5 was obtained. The reaction was digested for 1 hour. The resulting suspension of colloidal silica particles was recovered by filtration, washed and dried to form a finely divided porous silica powder useful in the production of absorbent particles.

To form granules and increase product density, 1 kg of the dried particles from each example above were and having a bulk density of about 0.50 g/ml were compacted in a roller compactor (model WP50N/75 available from Alexanderwerks GmbH, Germany) using a pressing force of 200-500 kP (40-70 bar) to form crayon-shaped agglomerates, which were then comminuted in a grinding process, pre-grinding using toothed-disk rollers (Alexanderwerks). The crude granules obtained were approximately 0.7 kg of 400-1600 μm sized granules. The granules were then sized by sieving as described above to recover granules sized between 850 μm and 425 μm. The target particle granules obtained in this manner have a bulk density of approximately 0.7 g/cc. Physical properties of the Examples 1-4 were determined according to the methods described above and results are summarized in the Tables below.

Several of the examples prepared above were evaluated for their capacity to absorb ammonia from air, both in terms of uptake and breakthrough. Uptake measurements provide evidence of the effectiveness of the adsorbent filter medium to remove and capture noxious gases, in this situation, as a test subject, ammonia gas, from within the test system in a certain period of time. Breakthrough measures the amount of time such a filter medium becomes saturated. A combination of high uptake with long breakthrough is thus the target for a suitable filter medium.

For the ammonia uptake tests, the following protocol was followed, basically in accordance with that set forth within Mahle, J., Buettner, L. and Friday, D. K., “Measurement and Correlation of the Adsorption Equilibria of Refrigerant Vapors on Activated Carbon,” Ind. Eng. Chem. Res., 33, 346-354 (1994). The precipitated silica adsorbent samples were loaded into a 15 μm frit-bottomed metal cell that allows airflow of a constant volume to be recycled through the cell in a closed loop system. The bed height of the filter medium was recorded after adding 100 mg of adsorbent (filter medium). The system is typically dry but the relative humidity of the system may be adjusted (Humid) by injecting a known quantity of water into the system to increase the relative humidity. The target ammonia concentration was 1100 mg/m³ in the closed loop system, which was equilibrated at 25° C., and the actual concentration of ammonia in the airstream was monitored using an infrared analyzer (MIRAN, Foxboro Company, Foxboro, Mass.). Ammonia was injected into the system through a septum located at the inlet (low pressure side) of the circulating pump.

The batch uptake test started with the adsorbent bed in the bypass mode. Ammonia was injected into the system and allowed to equilibrate. The mass of ammonia injected was determined by the volume of the gas-tight syringe. The infrared analysis was initially a redundant determination of the NH₃ mass injected. After the ammonia concentration stabilized, the bed bypass valve was changed to send the ammonia-contaminated air over the adsorbent (filter medium). The infrared analyzer then measured the gas-phase concentration change as a function of time.

A decrease in concentration outside the filter bed was an indication of ammonia removal from the air stream by the adsorbent. Precisely known weights of the subject gases allowed ammonia uptake to be measured, as well. The system temperature was increased from 25 to 75° C. after 100 minutes to determine if the ammonia captured up to that time was on the surface of the precipitated silica materials or within the pores (an increase in the concentration measurement within the headspace of the system indicated a release of ammonia from the filter medium). A release of ammonia from the silica materials noticed upon such a temperature increase was an indication that the capture of such gas occurred at the silica material surface since any captured within the pores by the metal complex would not be readily released from such a relatively low temperature increase.

To compare the performance of various samples using uptake data, the concentration of ammonia at various key time points was measured. To assess the ability of the precipitated silicas of this invention to remove ammonia quickly, the uptake concentrations in mg/m³ of ammonia absorbed before and after elevating the bed temperature to 25° C. Once that was performed, the bed temperature was increased to 75° C. to analyze the ability of the medium to release the ammonia. Tests were performed at humid conditions to show the enhanced performance of the inventive precipitated silica adsorbents of this invention.

A reduction in ammonia concentration to less than 400 mg/m³ at 25° C. was targeted to show effectiveness in ammonia removal. An ammonia concentration less than the initially measured concentration at that temperature upon exposure to 75° C. indicated the ability for ammonia regeneration. The lower the uptake level at that temperature, the better the results for ammonia regeneration.

TABLE
Summary of ammonia uptake rate and capacity

| | | | | Uptake | | |
|---|---|---|---|---|---|---|
| | | | | at 10 | | |
| | BET | | | minutes, | | |
| | Surface | | | mg | Maximum | Uptake |
| | Area, | Average pore | Pore Volume, | NH₃/m³ | Uptake at | at |
| Sample | m²/g | Diameter, | cc/g | at 25° C. | 25° C. | 75° C. |
| Example 1 | 1034 | 32 Å | 0.73 | 245 | 392 | 282 |
| Example 2 | 1245 | 23 Å | 0.95 | 272 | 352 | 243 |
| Example 3 | 528 | <20 Å | 0.14 | 282 | 392 | 260 |
| Example 4 | 1245 | 23 Å | 0.95 | 294 | 367 | 231 |
| Example 5 | 742 | 44 Å | 0.97 | 276 | 352 | 243 |
| Comparative | 750 | 16 Å | 0.41 | 199 | 407 | 295 |
| Example 1 | | | | | | |
| Comparative | 750 | 16 Å | 0.41 | 103 | 256 | 223 |
| Example 2 | | | | | | |
| Comparative | 250 | 200 Å | 0.5 | 250 | 268 | 270 |
| Example 3 | | | | | | |

Acidic silicic acid gel was produced that demonstrated faster uptake rate than standard commercial grade silica gel. Gel silicas produced by various methods showed better ammonia pick-up than standard commercial grade desiccant grade silica gel. Both the templated and non-templated methods of gel and/or precipitated silica production provided materials exhibiting faster pick-up rate and/or higher ammonia capacity. Silica produced by the precipitation process exhibits fast uptake and excellent ammonia retention as compared to standard commercial grade silica gel as well.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

What we claim is:

1. A filter medium comprising undoped precipitated silica or silicon-based gel materials, wherein said materials exhibit a BET surface area of between about 30 and 350 m²/g; a pore volume of greater than 0.25 cc/g to 2.0 cc/g as measured by nitrogen porosimetry; a mean pore diameter of greater than about 100 to 300 Å.

2. The filter medium of claim 1 wherein said materials are silicon-based gel materials.

3. A filter system comprising the filter medium as defined in claim 1.

4. A filter system comprising the filter medium as defined in claim 2.

5. A method of removing ammonia from an enclosed environment comprising the steps of providing a filter system comprising the filter medium as defined in claim 1, and exposing said filter system to an ammonia environment.

6. A method of removing ammonia from an enclosed environment comprising the steps of providing a filter system comprising the filter medium as defined in claim 2, and exposing said filter system to an ammonia environment.
